(19) United States
(12) Patent Application Publication
(10) Pub. No.: US 2026/0044115 A1
(43) Pub. Date: Feb. 12, 2026

(54) STACKED MEMBER, TIMEPIECE, AND METHOD FOR MANUFACTURING STACKED MEMBER

(71) Applicant: CASIO COMPUTER CO., LTD., Tokyo (JP)

(72) Inventor: Shouta NAGASAWA, Tokyo (JP)

(73) Assignee: CASIO COMPUTER CO., LTD., Tokyo (JP)

(21) Appl. No.: 19/283,630

(22) Filed: Jul. 29, 2025

(30) Foreign Application Priority Data
Aug. 8, 2024 (JP) 2024-133232
Jun. 2, 2025 (JP) 2025-092029

(51) Int. Cl. G04B 45/00

(52) U.S. Cl. CPC G04B 45/0076; G04B 45/0015

(57) ABSTRACT

A stacked member according to an embodiment includes, a base material made of a first material containing metal and having a plurality of grooves formed at a predetermined pitch on a surface; and a protective film stacked on the base material and having a surface shape following the surface of the base material, wherein the protective film is made of a material different from a metal oxide film of the first material and also different from a metal nitride film of the first material.

### CROSS REFERENCE TO RELATED APPLICATIONS

This application is based upon and claims the benefit of priority from prior Japanese Patent Application No. 2024-133232, filed Aug. 8, 2024; and No. 2025-092029, filed Jun. 2, 2025, the entire contents of both of which are incorporated herein by reference.

### FIELD

The present disclosure relates generally to a stacked member, a timepiece, and a method for manufacturing a stacked member.

### BACKGROUND

Jpn. Pat. Appln. KOKAI Publication No. 6-212451 describes a configuration to obtain a processed article having high decorativeness by forming a coating film, which is made of a reactant of a component of a metal material of a base material and a gas component of a reactive gas and has a second uneven portion formed at a position corresponding to a first uneven portion, on the base material made of the metal material having the first uneven portion in which a plurality of fine unevenness is formed.

### SUMMARY

A stacked member according to an embodiment includes,

a base material made of a first material containing metal and having a plurality of grooves formed at a predetermined pitch on a surface; and
a protective film stacked on the base material and having a surface shape following the surface of the base material, wherein
the protective film is made of a material different from a metal oxide film of the first material and also different from a metal nitride film of the first material.

### BRIEF DESCRIPTION OF DRAWINGS

FIG. 1 is a perspective view illustrating a configuration of a timepiece according to an embodiment.

FIG. 2 is an image of a part of a coloring member (parallel grooves) according to the embodiment as viewed from a front side.

FIG. 3 is an explanatory view illustrating a configuration and a manufacturing method of the coloring member according to the embodiment.

FIG. 4A is an image of a part of a coloring member according to Modification 1 as viewed from the front side. FIG. 4B is an image of a part of a coloring member according to Modification 2 as viewed from the front side. FIG. 4C is an image of a part of a coloring member according to Modification 3 as viewed from the front side.

FIG. 5 is a plan view illustrating a configuration of a part of a coloring member according to another Embodiment 1.

FIG. 6 is a plan view illustrating a configuration of a part of a coloring member according to another Embodiment 2.

### DETAILED DESCRIPTION

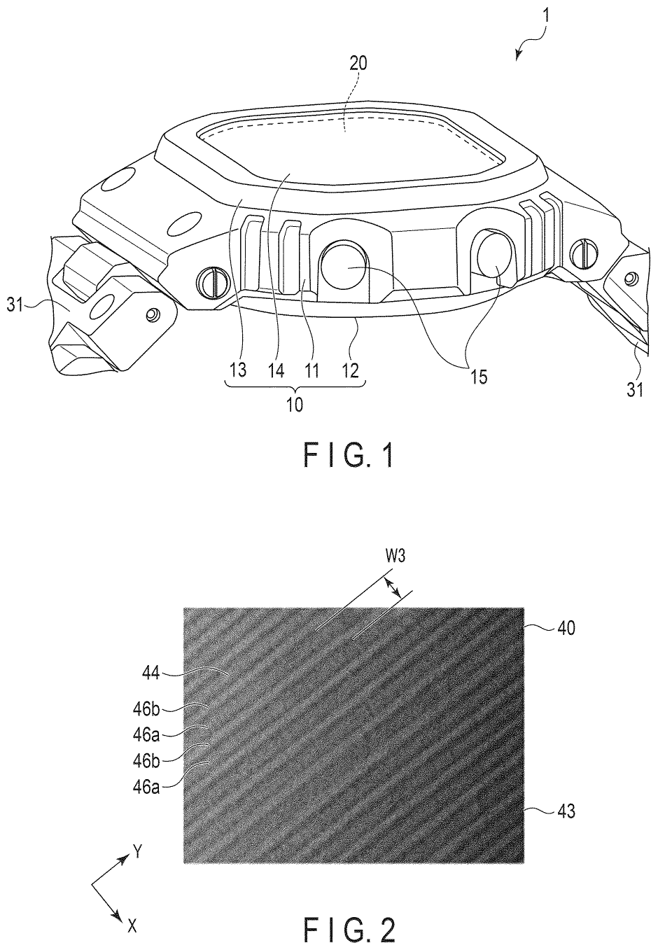

Hereinafter, a coloring member 40 as a stacked member and a method for manufacturing the coloring member 40 according to a first embodiment of the present disclosure will be described with reference to FIGS. 1 to 3. In the present embodiment, an example in which the coloring member 40 is applied to an exterior member of a timepiece 1 will be described.

Here, in a member having enhanced decorativeness such as the coloring member 40, durability of a film may be lowered depending on a method for enhancing the decorativeness. For example, Jpn. Pat. Appln. KOKAI Publication No. 6-212451 describes a configuration to obtain a processed article having high decorativeness by forming a coating film, which is made of a reactant of a component of a metal material of a base material and a gas component of a reactive gas and has a second uneven portion formed at a position corresponding to a first uneven portion, on the base material made of the metal material having the first uneven portion in which a plurality of fine unevenness is formed, and there is a problem that such a coating film containing the same metal material as the base material is easily worn and easily scratched since the film thickness is small.

The present disclosure has been made to improve and solve the problem in such a situation, and an object of the present disclosure is to provide a stacked member, a timepiece, and a method for manufacturing a stacked member capable of securing abrasion resistance and scratch resistance while enhancing decorativeness.

The timepiece 1 illustrated in FIG. 1 is, for example, a wristwatch worn on a wrist of a user. The timepiece 1 includes a timepiece case 10, and a timepiece module (not illustrated) provided inside an opening portion of the timepiece case 10. In addition, the timepiece 1 includes a timepiece band 31 connected to an outer peripheral portion of the timepiece case 10, and a plurality of switches 15 arranged on an outer periphery of the timepiece case 10.

The timepiece case 10 includes a case body 11 having a circular shape and having the opening portion, a back lid 12 disposed on a back side (back surface side) of a timepiece module 20, a bezel 13 disposed on the outer peripheral portion on a front side of the case body 11, and a transparent cover 14 that covers the front side (front surface side) of the opening portion of the case body 11 having the timepiece module 20 provided inside the opening portion. In the timepiece case 10, the case body 11 and the back lid 12 constitute a housing space in which the timepiece module 20 is disposed. As an example, the members of the respective parts such as the case body 11, the back lid 12, the bezel 13, and the cover 14 are concentric, or have the same shape in the case of a polygonal shape such as an octagon, for example, and have shapes fitted to outer shapes of target members to be assembled to each other.

The timepiece module 20 includes various components necessary for a timepiece function, such as a display unit provided with a dial and a pointer that displays information such as time and date, a movement that operates the display unit, a circuit board on which electronic components such as an IC and an antenna are mounted, and a battery. For example, the timepiece module 20 may be a digital system including a liquid crystal display panel or the like having a digital display function, or may be an analog system.

At least a part of a member visible from an outside, such as the timepiece band 31, the case body 11, or the back lid 12, of the timepiece 1 is constituted by a coloring member 40 having a coloring structure 44 exhibiting a structural color.

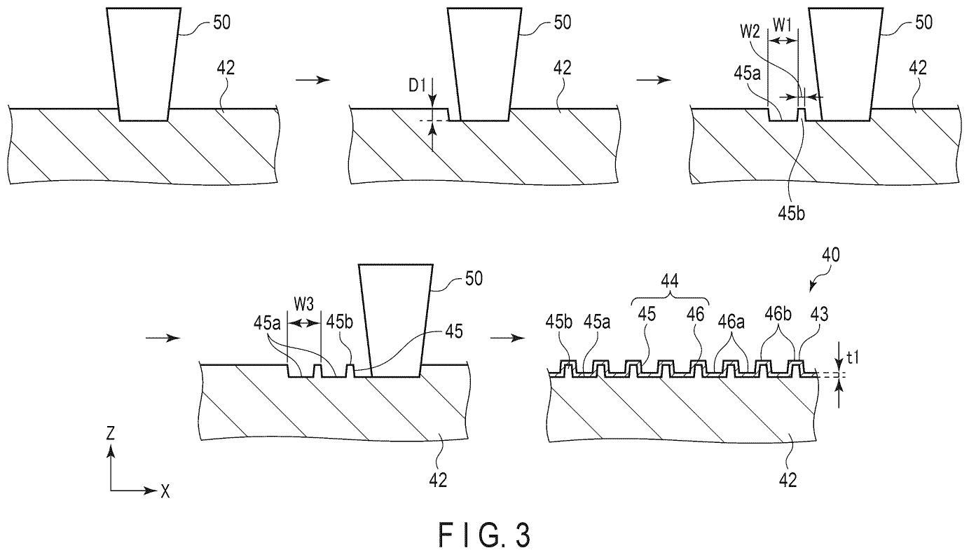

As illustrated in FIGS. 2 and 3, the coloring member 40 is a stacked member including a base material 42 and a protective film 43 formed on a surface of the base material 42, and constitutes the coloring structure 44. For example, the coloring member 40 is at least one of a timepiece band, a timepiece cover, a bezel, a knob, a dial, or a back lid. In the present embodiment, for example, the coloring structure 44 is formed on a surface portion of the timepiece band 31 as the coloring member 40.

The base material 42 is made of a first material containing metal, and is formed in a predetermined shape constituting the exterior member. For example, the first material is desirably a metal material having high hardness in order to improve durability of a fine shape of the surface. For example, the first material includes any of a cobalt alloy, titanium, a titanium alloy, or stainless steel. In various materials, it is desirable to increase the hardness by curing a base material. In addition, the material is not limited to metal, and may contain an inorganic compound such as cermet or ceramics. On the surface of the base material 42, a first uneven portion 45 having a recessed portion or a projecting portion and constituting the coloring structure 44 is formed.

The first uneven portion 45 includes a plurality of fine grooves 45a (recessed portions) formed in, for example, a surface layer portion of the base material 42, and arranged side by side at equal intervals in a predetermined first direction. That is, the plurality of grooves 45a is formed in the surface of the base material 42 at a predetermined pitch. For example, the first uneven portion 45 is configured by alternately forming the plurality of grooves 45a extending in parallel along a second direction and a plurality of projecting portions 45b formed between adjacent grooves 45a. The protective film 43 is further formed on the surface of the first uneven portion 45. The stacked member of the first uneven portion 45 and the protective film 43 exhibits an interference color by interference of light due to unevenness, and exhibits an appearance different from the appearance by the material of the protective film 43, for example. For example, the first uneven portion 45 has a structure in which reflection type diffraction grating appears on the surface of the protective film 43 formed on the surface. There are various processing methods for forming the first uneven portion 45. Examples of precision processing and micro-processing include machine processing, laser processing, and electron beam processing, nanoimprinting using a mold using these processing means, and a method using transfer characteristics of an amorphous alloy.

For example, in the first uneven portion 45, a width W1 in an arrangement direction (X direction) of the grooves 45a is set to less than 100 μm. A width W2 of a top face portion of the projecting portion 45b between a pair of the adjacent grooves 45a is configured to be less than 15 μm. A pitch (processing interval) W3 of the arrangement of the grooves 45a in the arrangement direction (X direction) is, for example, 1.4 μm or more and less than 115 μm.

The protective film 43 is made of a second material different from the first material constituting the base material 42. The second material is a material different from a metal oxide film of the first material and also different from a metal nitride film of the first material. To improve the durability of the fine shape of the surface, for example, the second material is a material harder than the first material. For example, the protective film 43 is a film formed of a hard material, and is formed on the surface of the base material 42 including the first uneven portion 45. Examples of the material of the protective film 43 include titanium (Ti), zirconium (Zr), aluminum (Al), chromium (Cr), tungsten (W), molybdenum (Mo), silicon (Si), niobium (Nb), and the like, a combination of these materials and a simple substance such as nitrogen (N), carbon (C), oxygen (O), or hydrogen (H), or a simple substance thereof. For example, as the hard protective film, a combination of diamond-like carbon (DLC), TiN, TiC, and TiCN is conceivable. As an example, the material of the protective film 43 includes diamond-like carbon.

In the present embodiment, the protective film 43 is made of diamond-like carbon (DLC). The protective film 43 is formed of, for example, a thin film having high uniformity, and has a surface shape following the surface shape of the base material 42. As an example, the protective film 43 is formed on the entire surface of the base material 42. The protective film 43 is formed on the surface of the base material 42 by, for example, vapor deposition, sputtering, IP, or the like. The shape of the first uneven portion 45 of the base material 42 is reflected on the surface of the protective film 43 on which the film is formed. That is, a second uneven portion 46 having an uneven shape corresponding to the first uneven portion 45 of the base material 42 and exhibiting a structural color is formed on the surface of the protective film 43. The protective film 43 is stacked on the base material 42, has the plurality of grooves 46a formed in the positions corresponding to the plurality of grooves 45a of the base material 42, and causes interference of light exhibiting a color on the surface due to unevenness of the surface. Note that the protective film 43 has poor abrasion resistance if the film thickness is small, and increases a film stress and has poor adhesion if the film thickness is large, and the grooves of the base are filled so that the uneven structure is not formed on the surface of the protective film 43. Therefore, the film thickness of the protective film 43 is preferably on the order of several μm. For example, the thickness of the protective film 43 is 0.5 μm or more and less than 10 μm. For example, the pitch of the grooves 46a formed in the protective film 43 is in a range of 1.4 μm or more and less than 115 μm.

The second uneven portion 46 appearing on the surface of the protective film 43 extends along the predetermined first direction (Y direction), and is configured by alternately forming the plurality of fine grooves 46a (recessed portions) arranged side by side in the second direction and the plurality of projecting portions 46b formed between the adjacent grooves 46a. The second uneven portion 46 constitutes a surface shape that separates light of different wavelengths by a repetitive structure in the diffraction grating. For example, the second uneven portion 46 has a color structure in which one or both of amplitude and phase of incident light change to generate interference fringes in emitted light. The second uneven portion 46 forms a stripe pattern and exhibits various colors depending on a viewing angle, thereby exhibiting iridescent coloration.

Therefore, the coloring structure 44 exhibiting the structural color is formed by the first uneven portion 45 of the base material 42 and the second uneven portion 46 of the protective film 43 formed thereon. In the coloring structure 44, the incident light is diffracted to be dispersed by the fine structure such as unevenness, thereby exhibiting a color different from that of the protective film 43.

A method for manufacturing the coloring member 40 according to the embodiment will be described with reference to FIG. 3. The method for manufacturing the coloring member 40 according to the present embodiment includes a surface processing process (step ST1) of forming the uneven structure on the surface of the base material 42 and a film forming process (step ST2) of forming the protective film 43 on the surface of the base material 42 after the surface processing process.

In the surface processing process (step ST1), the first uneven portion 45 having the uneven structure is formed on the surface of the base material 42 made of the first material such as the metal material. A processing apparatus is configured to be able to set, for example, various conditions such as intensity of light to be emitted, a type of light, output, etching depth, a scanning direction, a scanning distance, and a scanning pitch for each area as condition settings. For example, processing conditions can be set by setting a state of surface finish by setting the processing apparatus. For example, as illustrated in FIG. 3, by irradiating the surface of the base material 42 with a laser beam using a processing apparatus such as a laser processing machine 50 for which a processing region and processing conditions can be set, the plurality of grooves 45a along the first direction is formed in parallel in the second direction (X direction) at predetermined pitch intervals to form the first uneven portion 45 having the fine uneven structure. As an example, a laser beam having a spot diameter of 1 μm or more and less than 50 μm is used to form the first uneven portion 45 having the pitch W3 of 1.4 μm or more and less than 115 μm.

Further, after the surface processing process (step ST1), a material such as diamond-like carbon (DLC) is deposited as the second material on the surface of the base material 42 on which the first uneven portion 45 has been formed by the film forming process such as deposition, sputtering, or IP (step ST2) to form the protective film 43. At this time, as illustrated in

FIG. 3, by uniformly forming a film with a film thickness t1 of the protective film 43 in the range of 0.5 μm or more and less than 10 μm, the second uneven portion 46 having the uneven shape following the surface shape of the first uneven portion 45 of the base material 42 is formed on the surface of the protective film 43. As an example, the protective film 43 is formed on the entire surface of the base material 42.

According to the coloring member 40 and the timepiece 1 configured as described above, by forming the first uneven portion 45 having the fine uneven structure constituting the coloring structure 44 on the surface of the base material 42, the second uneven portion 46 exhibiting color can be formed on the surface of the protective film 43 formed on the surface of the base material 42. Therefore, a desired color can be exhibited regardless of the film thickness and color of the protective film 43. For example, DLC usually exhibits a black color, but iridescent coloration can be realized by scattering of light in a case where surface light of the protective film 43 enters, depending on the shape of the surface of the base material 42. Therefore, various patterns can be expressed regardless of the film thickness. Further, since the coloring member 40 according to the above-described embodiment is colored by the uneven structure, the coloring member is not decolored by ultraviolet rays or the like and has high sustainability. As described above, the present disclosure can provide a stacked member, a timepiece, a method for manufacturing a stacked member capable of securing functionality and appearance.

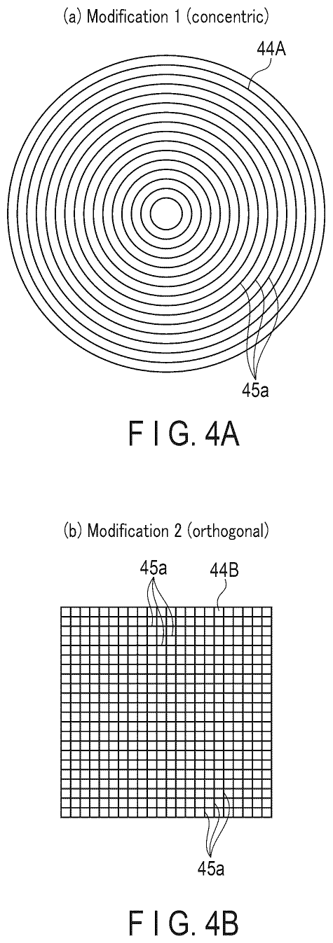

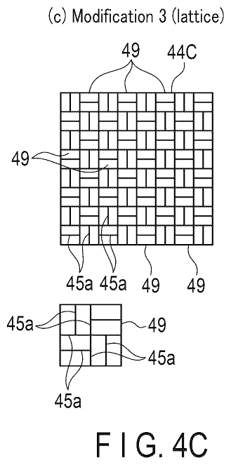

Note that the above-described embodiment is merely an example, and does not limit the scope of the disclosure. For example, in the above-described embodiment, the first uneven portion 45 and the second uneven portion 46 have the shapes in which the plurality of fine grooves 45a and 46a extending in parallel is arranged at a predetermined pitch, but the present embodiment is not limited thereto. The shape of the groove is not limited to a straight line and may be a curved line as long as the first uneven portion and the second uneven portion are arranged at a predetermined pitch. For example, as Modification 1, a plurality of arc-shaped grooves 45a may be concentrically provided as in a coloring structure 44A illustrated in FIG. 4A. In addition, as Modification 2, a configuration having a plurality of grooves 45a extending in a plurality of different directions may be adopted as in a coloring structure 44B illustrated in FIG. 4B. For example, the plurality of grooves 45a extend in directions orthogonal to each other. Alternatively, as Modification 3, a lattice-like configuration in which a plurality of unit structures 49 each having at least one groove 45a and having a shape of one basic unit is continuously formed may be adopted as in a coloring structure 44C illustrated in FIG. 4C. For example, the unit structure 49 is configured by combining a plurality of the grooves 45a extending in different directions, for example.

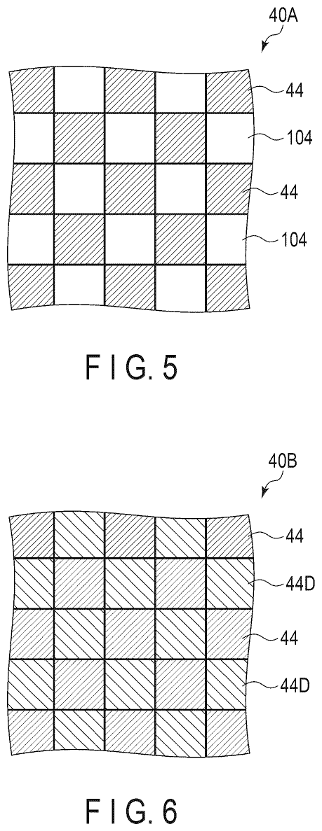

In the above-described embodiment, an example in which one kind of coloring structure 44 is formed on the entire surface of the coloring member 40 has been described, but the present embodiment is not limited thereto. For example, the coloring structure 44 may be formed only in a partial region of the surface of the exterior member. For example, each surface may be mirror-finished, and the coloring structure 44 may be provided only in a predetermined partial region. For example, in a coloring member 40A illustrated in FIG. 5 as another Embodiment 1, a coloring structure 44 is formed in some parts of a region divided into a checkered pattern, and the other portions are configured by mirror surface portions 104 having mirror surface finish. Further, as another Embodiment 2, as in a coloring member 40B illustrated in FIG. 6, a configuration including a plurality of coloring structures 44 and 44D having different surface processing conditions may be adopted. For example, the coloring member 40B is configured to exhibit a predetermined pattern as a whole by a set of the plurality of different coloring structures 44 and 44D. That is, it is possible to exhibit a different appearance for each region, and to express various patterns such as a crystal tone, a camouflage pattern, a carbon tone, a plain weave tone, and a fiber tone, depending on a contrast generated between the plurality of coloring structures 44 and 44D having different surface states or a contrast generated between the coloring structure 44 and a non-colored surface such as the mirror surface portion 104.

Further, in the above-described embodiment, the example in which the coloring member is applied to the timepiece band has been described, but the present embodiment is not limited thereto. For example, the present embodiment is also applicable to another member such as the cover, the bezel, the knob, the dial, or the back lid of the timepiece 1. Furthermore, for example, the present embodiment is not limited to the timepiece 1, and can be applied to various other articles.

Although some embodiments of the present disclosure have been described, the present disclosure is included in the disclosure described in the claims and the equivalent scope thereof.

What is claimed is:

1. A stacked member comprising:
a base material made of a first material containing metal and having a plurality of grooves formed at a predetermined pitch on a surface; and
a protective film stacked on the base material and having a surface shape following the surface of the base material, wherein
the protective film is made of a material different from a metal oxide film of the first material and also different from a metal nitride film of the first material.

2. The stacked member according to claim 1, wherein
the plurality of grooves is arranged in parallel to each other, and
the protective film causes interference of light and exhibits a color due to unevenness of the surface shape following the plurality of grooves parallel to each other.

3. The stacked member according to claim 1, wherein
the first material contains any one of a cobalt alloy, titanium, a titanium alloy, or stainless steel, and
the material of the protective film contains diamond-like carbon.

4. The stacked member according to claim 1, wherein the material of the protective film is harder than the first material.

5. The stacked member according to claim 1, wherein the predetermined pitch of the plurality of grooves is in a range of 1.4 μm or more and less than 115 μm.

6. The stacked member according to claim 1, wherein a thickness of the protective film is 0.5 μm or more and less than 10 μm.

7. A timepiece comprising the stacked member according to claim 1, wherein
the stacked member is at least one of a timepiece band, a timepiece cover, a bezel, a knob, a dial, or a back lid.

8. A method for manufacturing a stacked member, the method comprising:
forming a plurality of grooves at a predetermined pitch in a surface of a base material made of a first material containing metal;
forming, on the base material, a protective film that having a surface shape following the surface of the base material, made of a material different from a metal oxide film of the first material and also different from a metal nitride film of the first material.
